(19) United States
(12) Patent Application Publication
(10) Pub. No.: US 2024/0113341 A1
(43) Pub. Date: Apr. 4, 2024

(54) CYLINDRICAL SOLID-STATE BATTERY, AND METHODS OF MAKING AND USING THE SAME

(71) Applicants: RICHARD VAN DER LINDE, San Jose, CA (US); Arvind KAMATH, Los Altos, CA (US); Khanh TRAN, San Jose, CA (US); Yasumasa MORITA, San Jose, CA (US); Zhongchun WANG, San Jose, CA (US); Mihalis MICHAEL, San Jose, CA (US)

(72) Inventors: RICHARD VAN DER LINDE, San Jose, CA (US); Arvind KAMATH, Los Altos, CA (US); Khanh TRAN, San Jose, CA (US); Yasumasa MORITA, San Jose, CA (US); Zhongchun WANG, San Jose, CA (US); Mihalis MICHAEL, San Jose, CA (US)

(73) Assignee: Ensurge Micropower ASA, Oslo (NO)

(21) Appl. No.: 18/468,606

(22) Filed: Sep. 15, 2023

Related U.S. Application Data
(60) Provisional application No. 63/378,221, filed on Oct. 3, 2022.

(51) Int. Cl. H01M 10/0587; H01M 4/13; H01M 4/66; H01M 50/107; H01M 50/109; H01M 50/548

(52) U.S. Cl. CPC H01M 10/0587; H01M 4/13; H01M 4/661; H01M 50/107; H01M 50/109; H01M 50/548

(57) ABSTRACT

A cylindrical solid-state battery and methods of making the same are disclosed. The battery includes a solid-state battery cell wound, wrapped or rolled around a core or itself, first and second terminals on opposite ends of the battery, and packaging between the first and second terminals, sealing the cell therein. The cell comprises a cathode current collector (CCC), a cathode on the CCC, a solid-state electrolyte on the cathode, an anode current collector (ACC) on the electrolyte, an insulation film on the ACC with an opening therein exposing the ACC, and a conductive redistribution layer in the opening and on the insulation film and a first sidewall of the cell. One of the terminals is electrically connected to the ACC through the redistribution layer, and the other terminal is electrically connected to the cathode or CCC on the opposite end of the battery.

### CROSS-REFERENCE TO RELATED APPLICATIONS

This application claims the benefit of U.S. Provisional Pat. Appl. No. 63/378,221, filed Oct. 3, 2022, pending, incorporated herein by reference in its entirety.

### FIELD OF THE INVENTION

The present invention generally relates to the field of solid-state and/or thin film batteries. More specifically, embodiments of the present invention pertain to a cylindrical solid-state battery and methods of making and using the same.

### DISCUSSION OF THE BACKGROUND

Solid-state lithium batteries are ionic-charge storage devices that are ideally suited for wearable, IoT, and other non-EV applications due to their small size, safety, and high cyclability. Currently, they typically exist as single-cell devices, and require extrinsic packaging with relatively high area/volume overhead. These constraints limit the total charge capacity and volumetric energy density achievable. An additional disadvantage of the single-cell approach is that it generally needs to be relatively large in the x-y dimensions in order to carry sufficient charge capacity. This potentially large footprint can limit usage in area-constrained applications. To support a broader range of products and applications, a solution is desired that enables a relatively large battery cell.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to solid-state and thin film batteries, and more specifically to a cylindrical solid-state battery and methods of making and using the same. In one aspect, the present invention relates to a method of making a packaged solid-state battery, comprising forming a solid-state battery cell, winding, wrapping or rolling the solid-state battery cell around one or more cores, and enclosing the wound, wrapped or rolled solid-state battery cell in a housing having at least first and second terminals thereon or therein. The solid-state battery cell comprises a cathode on a conductive, flexible substrate, a solid-state electrolyte on or over the cathode, an anode current collector on or over the solid-state electrolyte, encapsulation on or over all surfaces of the substrate, the cathode, the solid-state electrolyte and the anode current collector, an opening in the encapsulation exposing the anode current collector, and a conductive redistribution layer on the exposed anode current collector and the encapsulation. The redistribution layer is also on a first sidewall of the solid-state battery cell. The method may further comprise forming a cathode current collector contact and an anode current collector contact in electrical contact with the cathode current collector and the anode current collector, respectively, and the wound, wrapped or rolled solid-state battery cell is enclosed in the housing in a manner enabling the cathode current collector contact and the anode current collector contact to be in electrical communication with the first and second terminals, respectively. Ideally, the method is useful for making cylindrical batteries, but it is also useful for making batteries having other shapes (e.g., prismatic batteries, pouch batteries, etc.).

The present invention also relates to a packaged solid-state battery, comprising a solid-state battery cell and first and second terminals on opposite sides or ends of the battery. The cells comprises a cathode current collector (CCC), a cathode on the cathode current collector, a solid-state electrolyte on the cathode, an anode current collector (ACC) on the electrolyte, a barrier and/or insulation film on the ACC with a via or opening therein exposing the ACC, and a conductive redistribution layer in the via or opening and on the barrier and/or insulation film. The barrier and/or insulation film and the redistribution layer are also on a first sidewall of the cell in that sequence. The solid-state battery cell is typically wound, wrapped or rolled around one or more cores, but in some embodiments, the core(s) may be removed (it may be wound or wrapped around or upon itself). One of the first and second terminals is electrically connected to the ACC through the redistribution layer on the first sidewall, and the other of the first and second terminals is electrically connected to each cathode or CCC on the second, opposite side or end of the battery.

The present packaged solid-state battery has a relatively high active battery area utilization and low packaging overhead, thereby maximizing battery energy density. Other capabilities and advantages of the present invention will become readily apparent from the detailed description of various embodiments below.

### BRIEF DESCRIPTION OF THE DRAWINGS

FIGS. 1-3, 4A, 5A, 6A, 7A and 8A are cross-sectional views of intermediate structures in an exemplary process of manufacturing a cylindrical solid-state battery, and FIGS. 4B, 5B, 6B, 7B and 8B are top-down views of the intermediate structures of FIGS. 4A, 5A, 6A, 7A and 8A, respectively.

FIGS. 9A-B are cross-sectional and top-down view, respectively, of an exemplary flexible solid-state battery strip according to embodiments of the present invention.

FIG. 10 is a side view of the battery strip of FIGS. 9A-B being wrapped or wound around a core, according to embodiments of the present invention.

FIGS. 11A-B are perspective views of exemplary cylindrical battery forms according to one or more embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

Herein, the term “core” refers to a relatively inflexible support around which the solid-state battery cell may be partially or fully wound or wrapped, and may include a tube, a rod having a cylindrical or rectangular parallelepiped shape, a plate or sheet (which may be relatively thick and which may have rounded edges), etc.

The present invention concerns a solid-state battery cell, a stacked solid-state battery, and methods of making the same. The present solid-state battery cell is an intrinsic anode-less battery, including a substrate, a cathode on the substrate, a solid-state electrolyte (SSE) on the cathode, and an anode current collector (ACC) on the SSE. The substrate, which generally comprises a metal foil, serves as the cathode current collector (CCC). Due to its anode-less nature, a conventional lithium anode may not be present between the SSE and ACC.

The following discussion provides examples of solid-state and/or thin film batteries, stacked solid-state batteries, and general manufacturing processes for such batteries.

An Exemplary Method of Making a Battery Stack with a Multi-Layer Solid-State Electrolyte

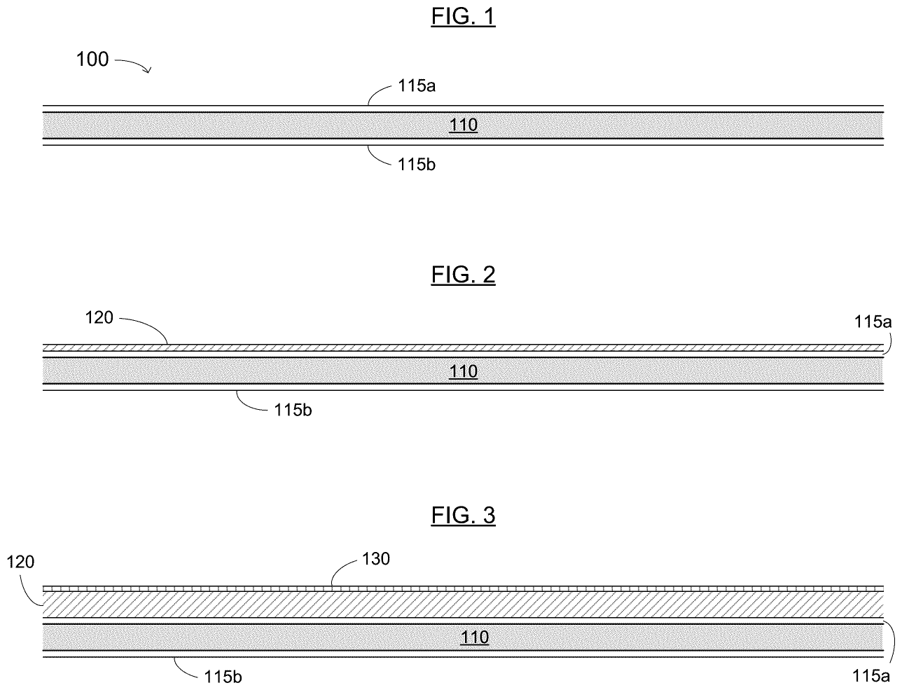

FIGS. 1-9B show intermediate and final structures in an exemplary method of making a cylindrical solid-state battery. FIG. 1 shows a substrate 100, comprising a metal foil, sheet or film 110 and optional first and second barriers 115a-b on opposite major surfaces of the metal foil, sheet or film 110. When the foil, sheet or film 110 is a metal foil, the first and second barriers 115a-b are not optional. The metal foil may comprise or consist essentially of stainless steel, aluminum, copper, nickel, inconel, brass, molybdenum or titanium, the elemental metals of which may be alloyed with up to 10% of one or more other elements to improve one or more physical and/or chemical properties thereof (e.g., oxygen and/or water permeability, flexibility, resistance to corrosion or chemical attack during subsequent processing, etc.). However, the sheet or film can also be a metal sheet or metal roll. For example, the sheet or film may be 10-100 μm thick, whereas a metal sheet may have a thickness of >100 μm, up to about 1-2 mm, although the invention is not so limited. Other alternative substrates include a metal coating on a mechanical substrate, such as aluminum, copper, nickel, titanium, etc., on a removable plastic film, sheet or roll.

The barrier 115a-b comprises one or more layers of one or more materials in a thickness effective to prevent migration of atoms or ions from the metal foil, sheet or film 110 into overlying layers. The barrier material(s) may comprise a glass or ceramic, such as silicon dioxide, aluminum oxide, silicon nitride, a silicon and/or aluminum oxynitride, etc., or a (refractory) metal nitride, such as aluminum nitride, titanium nitride, titanium aluminum nitride, tungsten nitride, titanium tungsten nitride, TiW alloy, tantalum nitride, etc. In some embodiments, each of the first and second barriers 115a-b comprises alternating glass/ceramic and metal nitride layers (e.g., a first metal nitride layer, a first glass/ceramic layer, and a second metal nitride layer, which may further comprise a second glass/ceramic layer, a third metal nitride layer, etc.). Each barrier 115a or 115b may have a total thickness of 0.05-3 μm, but the barrier 115 is not limited to this range. The barriers 115a-b may be blanket-deposited onto the foil, sheet or film 110 by chemical or physical vapor deposition (e.g., sputtering, thermal evaporation, atomic layer deposition [ALD], etc.), solution-phase coating with a precursor material followed by annealing to form the glass/ceramic or metal nitride, etc. Exemplary barrier materials, structures and thicknesses and methods for their deposition are disclosed in U.S. Pat. No. 9,299,845 and U.S. patent application Ser. No. 16/659,871, filed Oct. 22, 2019 (Atty. Docket No. IDR5090), the relevant portions of each of which are incorporated by reference herein.

In some embodiments, the foil, sheet or film 110 functions as a cathode current collector. In such embodiments, at least the barrier 115a (and optionally the barrier 115b) is a conductive, amorphous material, such as the metal nitrides listed above or an amorphous metal alloy (e.g., a TiW alloy).

FIG. 2 shows the metal substrate 100 with a cathode 120 thereon. The cathode 120 may comprise a lithium metal oxide or lithium metal phosphate, such as lithium cobalt oxide (LiCoO₂; LCO), lithium manganese oxide (LiMn₂O₄; LMO), or lithium iron phosphate (LiFePO₄; LFP), for example. The cathode 120 may be blanket deposited by laser deposition (e.g., pulsed laser deposition or PLD), sputtering, chemical vapor deposition (CVD), sol-gel processing, etc. Alternatively, the cathode 120 may be selectively deposited by screen printing, inkjet printing, spray coating, or extrusion coating (e.g., using an ink comprising one or more sol-gel precursors and one or more solvents, having a viscosity appropriate for the printing or coating technique).

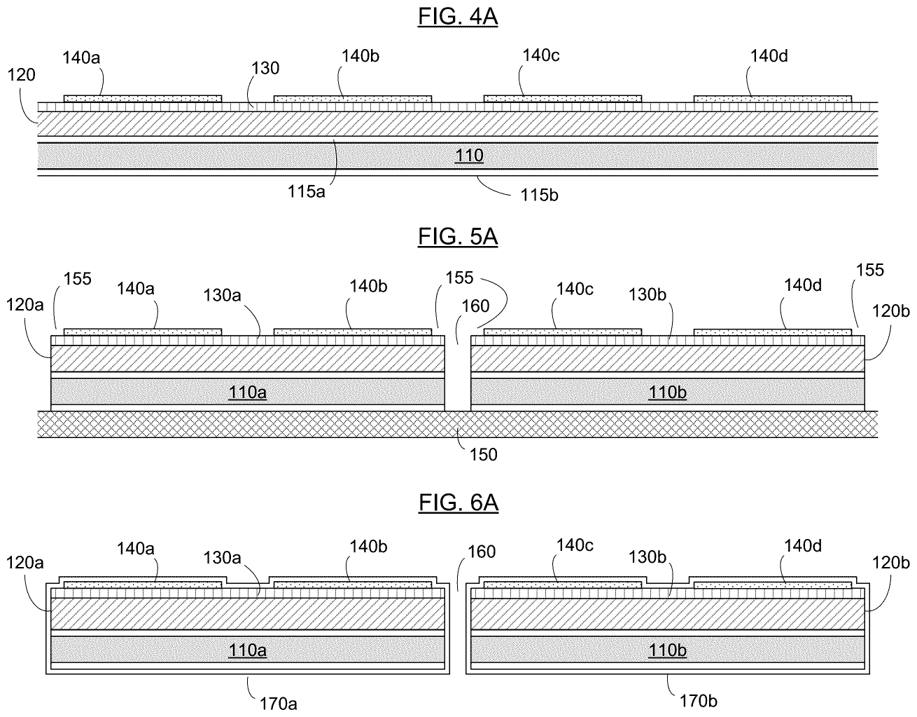

FIG. 3 shows a solid-state electrolyte 130 on the cathode 120. The electrolyte 130 may comprise or consist essentially of a conventional lithium phosphorus oxynitride (LiPON), which may optionally be carbon-doped, or Li₂WO₄, a good Li-ion conductor. In some embodiments, the electrolyte 130 may further comprise optional cathode and/or anode interface layers (not shown), each of which may comprise a lithiated metal oxide (see, e.g., U.S. patent application Ser. No. 17/185,111, filed Feb. 25, 2021, the relevant portions of which are incorporated herein by reference).

Forming the electrolyte 130 may comprise depositing a LiPON layer or a tungsten oxide layer of the formula WO_{3±x} (0≤x≤1) by sputtering, optionally using pulsed DC power. When the electrolyte 130 comprises LiPON, it may be deposited by RF sputtering or ALD. The sputtering target may comprise a Li₃PO₄ or mixed graphite-Li₃PO₄ target, the latter of which may contain 1-15 wt % of graphite, when the electrolyte 130 comprises LiPON or carbon-doped LiPON, and a metallic/elemental tungsten target when the electrolyte 130 comprises a tungsten oxide. In the latter case, sputtering is performed in an oxygen or oxygen-containing atmosphere. The method of making the electrolyte 130 may further comprise lithiating and thermally annealing the WO₃₊ₓ, which can transform it into Li₂WO₄, a good Li-ion conductor. Lithiating may comprise wet lithiation (e.g., immersing the WO₃₊ₓ in a solution containing a lithium electrolyte such as LiClO₄, LiPF₆, LiBF₄, etc., and applying an appropriate electric field) or dry lithiation (e.g., sputtering or thermally evaporating elemental lithium onto the tungsten oxide in a vacuum chamber, optionally while heating the substrate 100). Thermal annealing may comprise heating at a temperature of 150-500° C. for a length of time of 5-240 minutes, or any temperature or length of time therein (e.g., 250-450° C. for 10-120 minutes), in a conventional oven, a vacuum oven, or a furnace. To ensure substantially complete diffusion of the lithium into and/or throughout the WO₃₊ₓ, the WO₃₊ₓ should be annealed (preferably in air) at a temperature of at least 100° C. for at least 10 minutes (e.g., to transform it into Li₂WO₄).

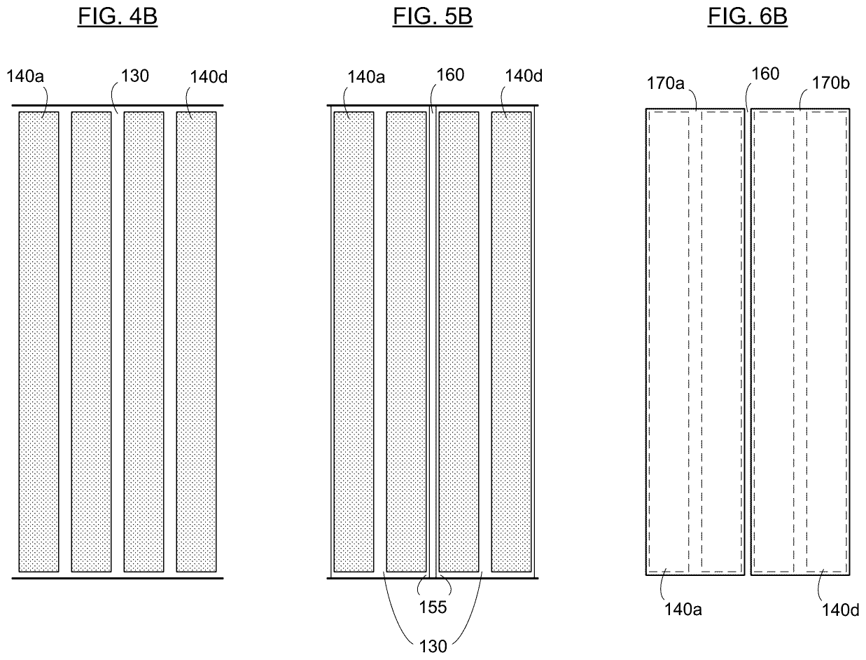

FIGS. 4A-B show a number of anode current collectors (ACCs) 140a-d on the electrolyte 130, thus forming substantially complete (but unsealed) cells. A separately-formed anode is not necessary in solid-state lithium batteries, as a lithium anode can be formed between the electrolyte 130 and the anode current collectors 140a-d during charging, if necessary. Optionally, however, a thin lithium anode can be deposited by evaporation onto the electrolyte 130 prior to formation of the anode current collectors 140a-d.

The anode current collectors 140a-d generally comprise a conductive metal, such as nickel, zinc, copper, alloys thereof (e.g., NiV), etc., or another conductor, such as graphite. The anode current collectors 140a-d can be selectively deposited by screen printing, inkjet printing, spray coating, etc., or formed by blanket deposition (e.g., sputtering or evaporation) and patterning (e.g., low-resolution photolithography, development and etching). The anode current collectors 140a-d may have a thickness of 0.1-5 μm, although it is not limited to this range.

The anode current collectors 140a-d may have area dimensions (i.e., length and width dimensions) that are 50-95% of the corresponding length and width dimensions, respectively, of the cell (see e.g., FIG. 8), although the borders of the anode current collectors 140a-d may be offset (pulled back) a minimal distance from the ultimate cell borders, in some embodiments. The pull-back distance of the ACCs 140a-d from the cell edges should be sufficient to electrically isolate the ACCs 140a-d from the CCC/substrate 100.

The cells may further include one or more interlayers that modify the interfaces between layers. For example, a metal oxide (e.g., Nb₂O₅, Al₂O₃, Li₄Ti₅O₁₂ or LiNbO₃) interlayer may be formed on the cathode 120 prior to deposition of the electrolyte 130 (e.g., to reduce interfacial stress, decrease interfacial resistance, or suppress formation of a space charge layer). An amorphous (e.g., elemental silicon) interlayer may be deposited on the electrolyte 130 prior to formation of the anode current collectors 140a-d to inhibit reduction of the electrolyte. Of course, the battery cell can be made in the reverse order (i.e., the anode current collector may be first formed on the substrate, then the remaining layers deposited in reverse order thereon).

An advantage of the present method is that some/all of the active battery layers (e.g., the cathode 120 and the solid-state electrolyte 130) are deposited as blanket layers. This maximizes the active area utilization of the battery cells for high intrinsic capacity, and also results in a topographically planar or “flat” cell to facilitate formation of the uppermost layer(s) and downstream packaging due to the pattern-free blanket-deposited layers. However, if necessary or desired, the cathode 120 and the SSE 130 can be slightly pulled back from the cell edge by subtractive patterning (e.g., low-resolution photolithography, laser ablation) or selective deposition (as described herein).

FIGS. 5A-8B show intermediate structures in a process for ACC-edge electrical isolation and cell encapsulation, followed by formation of an interconnect/via and redistribution layer for contact with the anode current collector 140. Referring to FIG. 5A, the substrate 100 is attached to a tape or sheet 150, and the electrolyte 130, the cathode 120 and the substrate 100 are cut or diced along the “ACC edge” 155 of the battery cells to form an opening 160 every other cell, or every other row or column of cells (when the cells are in an array or on a multi-column roll). The tape or sheet 150 is generally a UV release tape or sheet, containing an adhesive on one or both major surfaces that loses its adhesive properties upon sufficient irradiation with ultraviolet (UV) light. The tape or sheet 150 may be on a ring or other frame, configured to mechanically support the tape or sheet 150 and allow some tension therein. The ACC cell edges 155 are cut by laser (e.g., laser ablation), mechanical dicing or stamping, for example. When the cells are on a roll, they may also be cut or diced along the y-direction as shown in FIG. 5B between pairs of adjacent cells (e.g., every two cells) to form isolated cell pairs.

Referring to FIGS. 6A-B, after the diced cell pairs are released from the tape or sheet 150, the cell pairs are encapsulated with a mechanically compliant moisture barrier and electrical insulation film 170a-b. The barrier/insulation film 170a-b may comprise parylene or other polymer having similar mechanical strength (e.g., a relatively high tensile strength compared to polyethylene and/or polypropylene), Al₂O₃ or SiO₂ (either of which may be deposited at a relatively low temperature), combinations thereof (e.g., a parylene/Al₂O₃ bilayer), or another suitable barrier/insulation film. Additionally, the barrier/insulation film 170a-b may be coated with a polycarbonate or a diamond-like (e.g., amorphous carbon) coating for additional mechanical protection. The barrier/insulation film 170a-b covers all front, back and side surfaces of all cell pairs, and may be formed by pyrolysis, thermal CVD, ALD, inkjet printing, or screen printing.

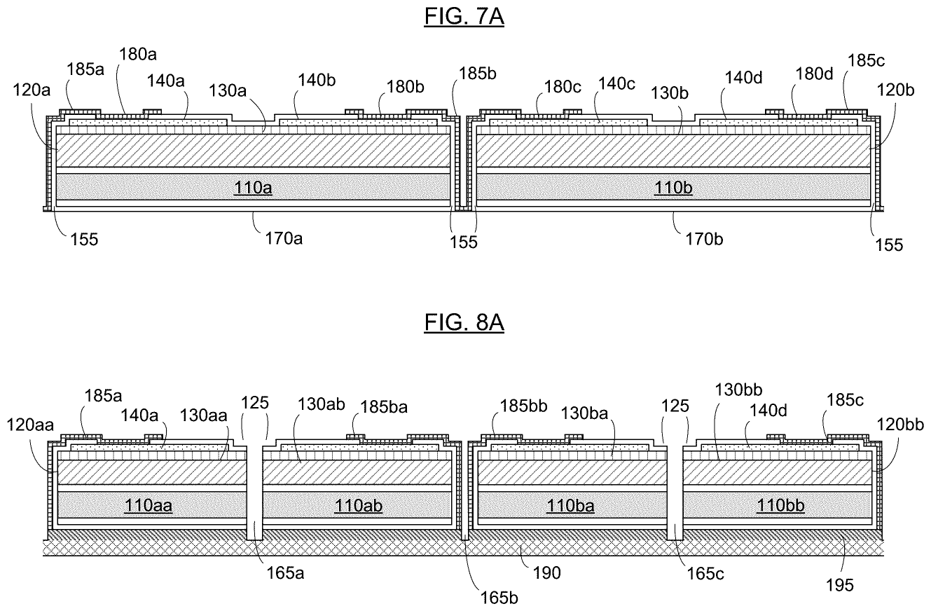

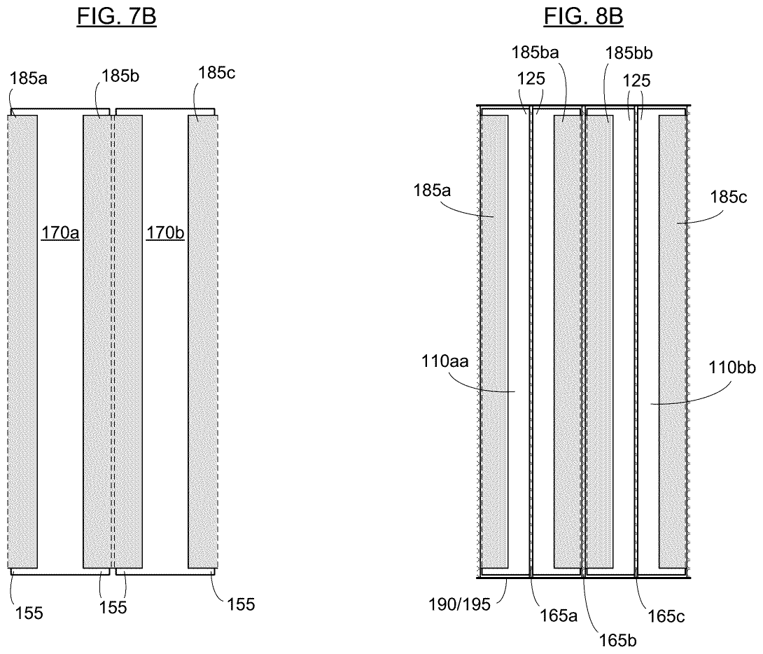

FIGS. 7A-B show formation of redistribution metal layers 185a-c along the ACC edges 155 and in vias or openings 180a-d in the barrier/insulation films 170a-b to connect the ACCs 140a-d to a subsequently formed external battery terminal. The vias or openings 180a-d may be formed in the barrier/insulation films 170a-b by (i) laser ablation or (ii) masking and etching. Alternatively, the vias or openings 180a-d may be formed by patterned encapsulation/deposition of the material(s) for the barrier/insulation films 170a-b on the upper surface of the cells. The redistribution layers 185a-c may comprise Cu, Ni, Al, or another suitable metal, and may be formed by sputtering or thermal evaporation (e.g., through a mask that exposes a region of the cell corresponding to the pattern of the redistribution layers 185a-c), followed by removal of the mask, or by selective deposition, such as inkjet printing or screen printing. A single redistribution layer (e.g., 185b) is on the ACC edges 155 of adjacent cells. The redistribution layers (or ACC traces) 185a-c go from the ACCs 140a-d exposed through the vias or openings 180a-d to the ACC edges 155, in the opposite direction from the CCC edges 125 (FIGS. 8A-B).

FIGS. 8A-B show singulated cells on substrates 110aa, 110ab, 110ba and 110bb. Prior to singulation (dicing), the cell pairs are placed on a tape 190. The tape may be coated with a thin adhesive layer 195. In this case, dicing along the CCC edges 125 (to form openings 165a-c) creates the single cells. The adhesive coating 195 on the tape 190 holds the cells on the tape during processing, and may provide a passivation and/or sealing layer on one side or surface of the cell during rolling (FIG. 10) and packaging/assembly. Thus, the coated tape 190/195 may comprise a conventional die attach film (DAF). Singulation may be conducted by laser dicing, but mechanical dicing and stamping are also possible. The adhesive coating 195 may also be cut during singulation, as may the tape 190. The redistribution layer 185b (FIGS. 7A-B) is cut to form separate layers 185ba and 185bb either during singulation or during removal (e.g., from a chuck or other deposition/patterning apparatus) at or near the end of the redistribution layer formation process.

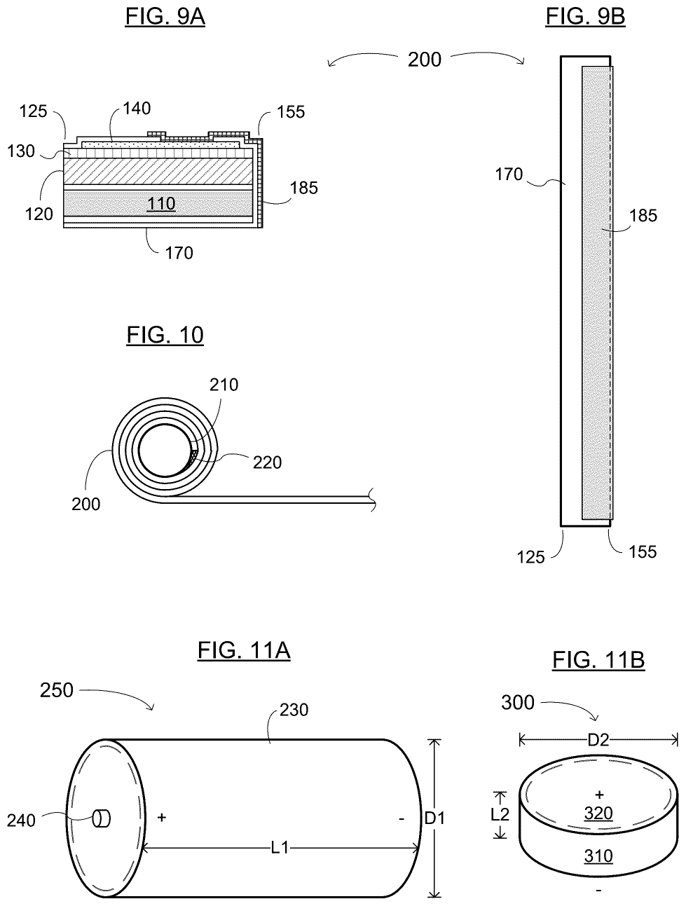

As shown in FIGS. 9A-B, a singulated cell 200 has a CCC (substrate) side or edge 125 of the cell, and an ACC side or edge 155 (including the ACC trace/redistribution layer 185) along the opposite side of the cell. The cell 200 may be separated from the tape 190 and/or the adhesive 195 by conventional techniques. The cell 200 forms a solid-state battery.

FIG. 9A shows a cross-section of an exemplary solid-state battery cell 200. The battery 250 includes a plurality of cells, each comprising a cathode current collector 110, a cathode 120 (e.g., LCO) on the cathode current collector (CCC) 110, a solid electrolyte 130 (FIGS. 1-9) on the cathode 120, an anode current collector (ACC) 140 on the electrolyte 130, a barrier/insulation film 170 with a via or opening 180 therein exposing the ACC 140, and a conductive redistribution layer 185 in the via or opening 180 and on the barrier/insulation film 170. The redistribution layer 185 is also on a first sidewall (the ACC edge 155) of the cell.

In some embodiments, a thin stainless-steel (SS) substrate 110 serves as the cathode current collector. In such embodiments, there is no need for a separate CCC layer, which consumes space in the battery cell 200 and increases complexity of the method of making the battery. SS is mechanically strong, and therefore, its thickness can be minimized (e.g., to 3-50 μm) to maximize cell energy density. The substrate 110 can be further encapsulated by a barrier metal 115a-b to suppress diffusion between the substrate and the cathode 120 (as well as any other overlying or underlying layer).

In some embodiments, the battery cell 200 includes an anode-free ACC 140, which may be defined with minimal pull-back from the cell edges. This design also maximizes area utilization. Furthermore, the use of an underlying blanket cathode 120 and a blanket solid-state electrolyte 130 results in a flat or planar ACC 140, which minimizes mechanical stresses from Li plating and/or stripping during cell cycling.

FIG. 10 is a side view of the cell 200 being rolled up around a core 210. The substrate 110 (e.g., FIG. 6A) has a thickness and/or flexibility (e.g., flexural modulus) that enables winding the cell 200 around the core 210. The core 210 may comprise a non-reactive, mechanically stiff material such as a thermoset organic polymer (an epoxy polymer, a polycarbonate, a polyamide [e.g., an aramid] or polyimide, a phenol-aldehyde polymer [e.g., BAKELITE® resins (BAKELITE is a registered trademark of Union Carbide Corporation, New York, NY) or a high-modulus thermoplastic organic polymer (e.g., high-density polyethylene), an electrically insulating ceramic, etc., and may be solid or hollow (e.g., cylindrical or tube- or pipe-shaped). If hollow, the core 210 may contain a material to facilitate long-term operation (e.g., charging and re-charging cycles) of the battery, such as a desiccant, an oxygen scavenger, etc.

The dimensions of the core 210 may be determined by the form and dimensions of the standard packaged/sealed battery. For example, when the standard packaged/sealed battery is a “AA” battery, the core 210 may have a length of 40-49 mm and a diameter of 1-10 mm, or any values or range of values therein. Alternatively, the core 210 may have a length that is from 1 to 15 mm smaller than the commercially-accepted length of the standard form of the battery (e.g., “AAA,” “A”, “A23”, “A27”, “B,” “C,” “D,” “N,” etc.). The present method may also be used to make coin-shaped and/or button-sized batteries and cells, such as those having a shape and/or form as shown in FIG. 11B and/or a standard size IEC cell form defined by the prefix “CR,” which typically produce 3 volts, “LIR” (referring to lithium ion rechargeable batteries), or “BR” (e.g., “CR1025,” “CR1254,” “CR1654,” “BR1025,” “BR1254,” “BR1654,” “LIR1025,” “LIR1254,” “LIR1654,” etc.).

For lithium ion batteries, commonly-used designation numbers indicate the physical dimensions of the cylindrical cell, as set forth in IEC standard 60086-1 (the relevant portions of which are incorporated herein by reference) for cylindrical primary cells. For example, the first two digits of the designation number are the nominal diameter of the cell in millimeters, and the three following digits of the designation number are the height in tenths of millimeters.

To initiate the rolling or winding process, a major surface of the cell 200 (either the major surface closest to the substrate 110 or the major surface closest to the anode current collector 140) may be pressed against the core 210 (or vice versa) at one end of the cell 200 so that the axis of the core 210 is perpendicular to the longest dimension of the cell 200. As shown in FIG. 10, there may be a gap 220 between the core 210 and the cell 200 at or near the end of the first winding (i.e., the first layer of the cell 200, closest to the core 210). Alternatively, when the end of the cell 200 and the core 210 are held together with an adhesive (which may be or comprise the adhesive layer 195, FIG. 8A), some adhesive may fill some or all of the gap 220.

Rolling or winding the cell 200 around the core 210 may comprise use of a conventional battery winding machine (e.g., an SJR-18650 or YH-SW-C automatic or semi-automatic winder, commercially available from TOB New Energy Ltd., Xiamen City, Fujian Province, China). Tension may be applied to the substrate using one or more rollers to allow for compression across the entire cell, as well to allow for expansion and contraction during charging and discharging, respectively. A thin, interleaved layer (e.g., a mechanical film or support, such as a thin strip of paper or plastic tape) may be added above or below the substrate to facilitate expansion and contraction during winding. A flange connected to the core may allow for winding the cell around the core, with roller tensioners applying suitable tension across the substrate and cell during winding. The tension may be adjusted (e.g., periodically, continuously, or as needed) from the beginning of the winding to the end of the winding.

After rolling or winding, an ACC contact is made to the redistribution layer 185, and a CCC contact is made to the side or end 125 of the cell 200 with the exposed conductive substrate 110. One or more control circuits may be placed at one or both ends of the rolled or wound (i.e., cylindrical) cell 200, adjacent to the cell 200, but inside any exterior shell or housing. The control circuit(s) may be in contact with one or both of the ACC 140 and the ACC contact, one or both of the CCC (substrate 110) and the CCC contact, and if present, an internal or external ground potential. Generally, when present, the control circuit is in contact with at least one of the ACC 140 and the ACC contact, and at least one of the CCC (substrate 110) and the CCC contact.

The present method may also be used to make prismatic cells, which comprise one or more sheets of cells sandwiched, folded or rolled up, and optionally pressed to fit into a metallic or hard plastic housing having a cubic, rectangular cubic/parallelepiped, or substantially cubic or rectangular cubic/parallelepiped form. The cell(s) 200 may be wrapped or wound around a core having a square or rectangular cross-section, or a substantially stiff plate or sheet. Two or more cells 200 can be wrapped or wound around the core by first securing an end of each cell 200 to a unique planar surface of the core, plate or sheet, and rotating the core, plate or sheet while maintaining some minimal tension on the cell 200. Examples of prismatic cell battery forms include PP3 or E (e.g., “9-volt”) and lantern batteries. The electrodes (e.g., the anode and cathode, in electrical contact with the ACC and the CCC, respectively) in such prismatic batteries can be assembled by layer stacking at each end of the rolled cell strip, rather than by rolling or winding.

The present method can also be used to make pouch-style batteries (e.g., as found in many cellular phones). Although the cells in a pouch battery are typically stacked or folded, a singular, long-aspect ratio cell may be wound around two spaced-apart cores that can be removed before placing or inserting the wound or wrapped cell in the pouch.

Battery terminals and packaging may be placed on and/or around the wound battery cell shown in FIG. 10. For example, end terminals at the CCC and ACC edges 125 and 155 (e.g., the exposed edges of [i] the cathodes 120 or CCCs 110 and [ii] the redistribution layers 185, respectively) are dipped into or coated with a conductive epoxy to electrically gang the terminals and respectively form the CCC terminal and ACC terminal of the packaged battery (see, e.g., FIGS. 11A-B, which show the positive terminal 240 and 310, respectively, which are in turn in electrical contact with or otherwise electrically connected to the CCC terminal in this manner). The conductive epoxy may comprise an Ag-filled or Ni-filled conductive epoxy paste. Alternatively, a pin-to-pin paste transfer method may be used. Plating part or all of the CCC terminal and ACC terminal also creates a solderable surface for PCB attachment by the end user. For solderable termination, the epoxy surface may be plated with Ni, then with In or Sn.

An Exemplary Cylindrical Solid-State Battery

FIG. 11A shows a packaged battery 250, with the wound cell inside a housing 230. The view of the battery 250 in FIG. 11 shows an external positive terminal 230. A conventional negative terminal (not shown) is at the opposite end of the battery 250. The battery 250 may have a cylindrical “AA,” “C” or “D” form as shown, although other forms are also applicable, as described herein. The negative and positive terminals are respectively electrically connected to the ACC (e.g., through the redistribution layer 185) on the first side and to the cathode or CCC on the second, opposite side.

Prior to packaging in the housing 230, the cylinder wall of the wound/cylindrical cell 200 may be coated with a sealant and/or adhesive to protect the active components of the cell 200 from water, oxygen, contaminants, etc., and to facilitate placement of the housing 230 on and/or around the cell 200. For example, the wound/cylindrical cell 200 may be coated with a mechanically-compliant moisture barrier and/or an electrically-insulating film. Some materials, such as parylene, Al₂O₃ or SiO₂, combinations thereof (e.g., a parylene/Al₂O₃ bilayer), etc., are suitable for both functions. The battery housing 230 is generally formed conventionally, by any known process for manufacturing cylindrical batteries. Similarly, conventional processes for packaging and/or assembling prismatic batteries and pouch-style batteries. Thus, the battery housing 230 may comprise an adhesive layer on an electrical insulator, in turn on an outer layer of a mechanically robust moisture barrier (e.g., paper having a thickness of 0.1-5 mm, a metal foil or sheet having a thickness of 0.1-1 mm, an organic polymer such as high-density polyethylene, high-density polypropylene, an epoxy polymer, a polycarbonate, a polyamide such as an aramid, a polyimide, a phenol-aldehyde polymer, etc., having a thickness of 0.1-1 mm, or a combination or laminate thereof) that serves as the exterior surface of the battery 250.

FIG. 11B shows a coin-shaped solid-state battery 300 comprising a housing 310 with a positive terminal 320 thereon. The battery 300 also includes a negative terminal ([−]; not shown) on the opposite circular surface of the battery 300 from the positive terminal 320. As can be seen by comparing FIG. 11B with FIG. 11A, the battery 300 has a cylindrical length L2 smaller than its diameter D2, whereas the battery 250 has a cylindrical length L1 greater than its diameter D1. In some cases, the battery 250 of FIG. 11A may have an aspect ratio (i.e., the ratio L1:D1 or L1/D1) of m:1, where m is a number of 3, 4 or more, and the battery 300 of FIG. 11B may have an aspect ratio (i.e., the ratio L2:D2 or L2/D2) of 1:n, where in is a number of 3, 4 or more. The exact ratio of the present battery's cylindrical length L to its diameter D depends on its form (e.g., standard form).

The present solid-state battery and method are unique from previous solutions, and have the following differentiation(s):
No ceramic substrate, which removes the need for an additional CCC layer. The absence of a CCC layer reduces the volume of the battery cell, increasing battery capacity and current flux per unit volume, and decreases process complexity.
Some embodiments include a stainless steel (SS) substrate, which is mechanically strong, enabling its thickness to be minimized to maximize cell energy density. SS substrates can be further encapsulated by a barrier metal/conductor to suppress inter-diffusion between the substrate and the cathode (and other layers of the cell).
In some embodiments, at least some active battery layers are blanket-deposited (no patterning), which improves total active area (maximum intrinsic charge capacity) and area efficiency, decreases process complexity, and eliminates potentially challenging topographies (e.g., during assembly and/or packaging).
A planar, anode-free anode current collector may be defined with minimal pull-back from cell edges, providing the same area utilization advantages as above, and minimizing mechanical stresses from lithium plating/stripping during cell cycling.
ACC-edge electrical isolation and cell encapsulation, followed by formation of an interconnect via and redistribution layer for anode contact, allows the entire cell to be encapsulated with a mechanically compliant moisture barrier and electrical insulation film, and the redistribution layer (“ACC trace”) to route the ACC current to the “ACC edge” of the cell, opposite from the “CCC edge” of the cell. This arrangement also avoids any need to design or form a separate contact pad for the ACC or CCC. Thus, the via/opening and redistribution layer enable a packaged, cylindrical solid-state battery with correctly oriented, efficient electrical termination.
Cell strip singulation includes dicing on the opposite side of the ACC trace, exposing the conductive substrate at the CCC edge for the CCC contact.
The cell strip can then be wound around one or more cores, or wrapped around a plate or sheet. The core(s), as well as the plate or sheet, can have dimensions that ensures the cell strip is not bent beyond a minimum radius and/or to ensure that the bending stress on the cell does not exceed a predefined threshold.

### CONCLUSION

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A method of making a packaged solid-state battery, comprising:
forming a solid-state battery cell comprising:
a cathode on a conductive, flexible substrate,
a solid-state electrolyte on or over the cathode,
an anode current collector on or over the solid-state electrolyte, and
encapsulation on or over the substrate, the cathode, the solid-state electrolyte and the anode current collector;
winding, wrapping or rolling the solid-state battery cell around one or more cores; and
enclosing the wound, wrapped or rolled solid-state battery cell in a cylindrical housing having at least first and second terminals thereon or therein.

2. The method of claim 1, wherein the encapsulation includes an opening exposing the anode current collector, and the solid-state battery cell further comprises a conductive redistribution layer on the exposed anode current collector, the encapsulation, and a first sidewall of the solid-state battery cell.

3. The method of claim 1, wherein the substrate functions as a cathode current collector (CCC) for the battery cell.

4. The method of claim 1, further comprising forming a cathode current collector contact in electrical contact with the substrate and an anode current collector contact in electrical contact with the anode current collector.

5. The method of claim 3, wherein the wound, wrapped or rolled solid-state battery cell is enclosed in the housing in a manner enabling the cathode current collector contact to be in electrical communication with the first terminal and the anode current collector contact to be in electrical communication with the second terminal.

6. The method of claim 1, wherein the substrate comprises a metal foil.

7. The method of claim 6, wherein the solid-state battery cell further comprises a first barrier on a first major surface of the metal foil, the first barrier having a thickness effective to prevent migration of atoms or ions from the metal foil into overlying layers.

8. The method of claim 7, wherein the solid-state battery cell further comprises a second barrier on an opposite major surface of the metal foil, the second barrier having a thickness similar or identical to the first barrier.

9. A packaged solid-state battery, comprising:
a solid-state battery cell wound, wrapped or rolled around one or more cores or wound or wrapped around or upon itself, the solid-state battery cell comprising:
a cathode current collector (CCC),
a cathode on the cathode current collector,
a solid-state electrolyte on the cathode,
an anode current collector (ACC) on the electrolyte,
an insulation film on the ACC with a via or opening therein exposing the ACC, and
a conductive redistribution layer in the via or opening and on the insulation film, wherein the insulation film and the redistribution layer are also on a first sidewall of the cell;
first and second terminals on opposite sides or ends of the battery, wherein one of the first and second terminals is electrically connected to the ACC through the redistribution layer on the first sidewall, and the other of the first and second terminals is electrically connected to the cathode or CCC on the opposite side or end of the battery; and
packaging or a housing between the first and second terminals, sealing and containing the solid-state battery cell therein.

10. The packaged solid-state battery of claim 9, wherein the packaging or the housing is cylindrical.

11. The packaged solid-state battery of claim 10, wherein the packaging or the housing has dimensions compliant with a standard or commercially-accepted battery form.

12. The packaged solid-state battery of claim 11, wherein the packaging or the housing complies with a “AAA,” “AA,” “A”, “A23”, “A27”, “B,” “C,” “D,” or “N” battery form, or a standard size IEC cell form defined by a prefix “CR,” “LIR” or “BR.”

13. The packaged solid-state battery of claim 11, wherein the packaging or the housing complies with a coin-shaped battery form.

14. The packaged solid-state battery of claim 13, wherein the packaging or the housing complies with a standard size IEC cell form defined by a prefix CR or BR.

15. The packaged solid-state battery of claim 9, wherein the solid-state battery cell wound, wrapped or rolled around the core(s).

16. The packaged solid-state battery of claim 9, wherein the CCC comprises a metal foil.

17. The packaged solid-state battery of claim 16, further comprising a first barrier on a first major surface of the metal foil, the first barrier having a thickness effective to prevent migration of atoms or ions from the metal foil into overlying layers.

18. The packaged solid-state battery of claim 17, wherein the solid-state battery cell further comprises a second barrier on an opposite major surface of the metal foil, the second barrier having a thickness similar or identical to the first barrier.
